(19) United States
(12) Patent Application Publication
(10) Pub. No.: US 2005/0027618 A1
(43) Pub. Date: Feb. 3, 2005

(54) Third party privacy system

(75) Inventors: Jeffrey Mark Zucker, Dallas, TX (US); Douglas L. Peckover, Dallas, TX (US); Ralph Spencer Poore, Arlington, TX (US)

Correspondence Address: HAYNES AND BOONE, LLP, 901 MAIN STREET, SUITE 3100, DALLAS, TX, 75202, US

(73) Assignee: Privacy Infrastructure, Inc., Dallas, TX (US)

(21) Appl. No.: 10/924,626

(22) Filed: Aug. 24, 2004

Related U.S. Application Data
(63) Continuation of application No. 09/100,671, filed on Jun. 19, 1998.
(63) Continuation-in-part of application No. 08/784,829, filed on Jan. 17, 1997, now Pat. No. 6,119,101.
Application No. 09/100,671 is a continuation-in-part of application No. 08/970,470, filed on Nov. 14, 1997, now Pat. No. 6,286,002.
(60) Provisional application No. 60/050,411, filed on Jun. 20, 1997.
(60) Provisional application No. 60/052,373, filed on Jul. 11, 1997.
(60) Provisional application No. 60/057,685, filed on Aug. 27, 1997.
(60) Provisional application No. 60/010,087, filed on Jan. 17, 1996.
(60) Provisional application No. 60/057,685, filed on Aug. 27, 1997.
(60) Provisional application No. 60/052,373, filed on Jul. 11, 1997.
(60) Provisional application No. 60/050,411, filed on Jun. 20, 1997.
(60) Provisional application No. 60/047,341, filed on May 21, 1997.

(51) Int. Cl. G06F 17/60; H04K 1/00; H04L 9/00

(52) U.S. Cl. 705/26; 705/39

(57) ABSTRACT

A system and method of providing privacy through anonymity is described. As one aspect of the invention, a person registers at a privacy server and is given a pseudo identity that can be used to browse, register, purchase, pay for, and take delivery of products and services. Transactions are completed with the privacy server on a need-to-know basis. A seller communicates with the privacy server but only sees a demand, not the identity of the buyer. The financial institution communicates with the privacy server and sees the payment, not the merchandise. The freight company communicates with the privacy server and sees the package, not its contents. The privacy server operates in a manner that assures privacy and anonymity for the buyer and, if necessary, both the seller as well.

### CROSS REFERENCES TO RELATED APPLICATIONS

This application relates to the following group of applications. Each application in the group relates to, and incorporates by reference, each other application in the group. The invention of each application is assigned to the assignee of this invention. The group of applications includes the following.

“Intelligent Agents for Electronic Commerce,” application Ser. No. 08/784,829, filed Jan. 17, 1997, having inventor Douglas L. Peckover, and claiming priority from,

“Intelligent Agents for Electronic Commerce,” application No. 60/010,087, filed Jan. 17, 1996, having inventor Douglas L. Peckover.

“Third Party Privacy System,” application No. 60/050,411, filed Jun. 20, 1997, having inventors Douglas L. Peckover and Jefferey M. Zucker.

“Agent Technology for Newsgroups,” application No. 60/047,341, filed May 21, 1997, having inventors Carolyn Barthelenghi and Douglas L. Peckover.

“Ad Agent Method and Apparatus,” application No. 60/052,373, filed Jul. 11, 1997, having inventors Carolyn Barthelenghi and Douglas L. Peckover.

“Analysis and Communication Tools for a System,” application No. 60/057,685, filed Aug. 27, 1997, having inventor Douglas L. Peckover.

“Integrated Search and Communications System,” application Ser. No. 08/970,470, filed Nov. 14, 1997, having inventors Jack Axaopoulous, James F. Carpenter and Douglas L. Peckover.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### THE FIELD OF THE INVENTION

This invention relates to the field of electronic privacy. In particular, the invention relates to privacy in commercial transaction where electronic communications systems are used.

### BACKGROUND OF THE INVENTION

As electronic commerce grows in importance, the possibility of maintaining one's privacy becomes more difficult. It has been asserted that the value of a network increases proportionally to the number of nodes in the network squared. It has also been asserted that the likelihood of maintaining one's privacy decreases as the square of the number of nodes in the network.

As consumers make more and more purchases, suppliers and others can build up large databases of information about consumers' purchase preferences. The privacy of the consumer is lost.

There is presently no system that allows a user to simply initiate a purchase of a physical good without exposing identifying information about the user. Many types of computer communications can be performed using anonymous techniques. However, no system presently allows consumers to make purchases anonymously.

Therefore, what is desired is an improved privacy system that allows consumers to make anonymous purchases.

### A SUMMARY OF THE INVENTION

A system and method of providing privacy through anonymity is described. As one aspect of the invention, a person registers at a privacy server and is given a pseudo identity that can be used to browse, register, purchase, pay for, and take delivery of products and services. Transactions are completed with the privacy server on a need-to-know basis. A seller communicates with the privacy server but only sees a demand, not the identity of the buyer. The financial institution communicates with the privacy server and sees the payment, not the merchandise. The freight company communicates with the privacy server and sees the package, not its contents. The privacy server operates in a manner that assures privacy and anonymity for the buyer and, if necessary, the seller as well.

In some embodiments, the invention includes only the privacy server. Other embodiments include the communications system supporting the privacy server. Other embodiments include only the software (that is used by the server and/or the consumer and/or the seller and/or the financial institute and/or the freight company) on media or in an electromagnetic waveform.

The system is for all of commerce, and may be used in electronic commerce or by people who prefer more conventional commerce, such as a phone call or in-store visit.

Privacy through anonymity produces more accurate information for sellers, enabling new business tools that permit buyers' needs to be fulfilled more accurately.

The system has special provisions for protecting the privacy and anonymity of children. Parents are given direct control and supervision over their child's relationships, as well as where the child is permitted to visit on the Internet.

Although many details have been included in the description and the figures, the invention is defined by the scope of the claims. Only limitations found in those claims apply to the invention.

### A BRIEF DESCRIPTION OF THE DRAWINGS

The figures illustrate the invention by way of example, and not limitation. Like references indicate similar elements.

FIG. 1 illustrates a third party privacy system.

FIG. 2 through FIG. 11 illustrate data structures that can be used in the system of FIG. 1.

FIG. 12 through FIG. 15 illustrate example screen output from various locations in the system of FIG. 1.

### THE DESCRIPTION

Definitions

The following terminology will be helpful in understanding various embodiments of the invention.

A product can be either a good or a service.

A consumer, or buyer, is any person or company that purchases products, or would otherwise be interested in receiving information about a product.

A supplier, or seller, is any person or company that supplies products, or would otherwise be interested in receiving consumer needs' information about products.

A financial institution is anyone who would provide credit. In the examples described herein, the same financial institution is used in the description. It is important to note that multiple different financial institutions would normally use the system.

A freight company is anyone who would ship goods.

A user is a person or company that accesses the system. The user can be a consumer, buyer, supplier, or seller.

Figure Descriptions Details

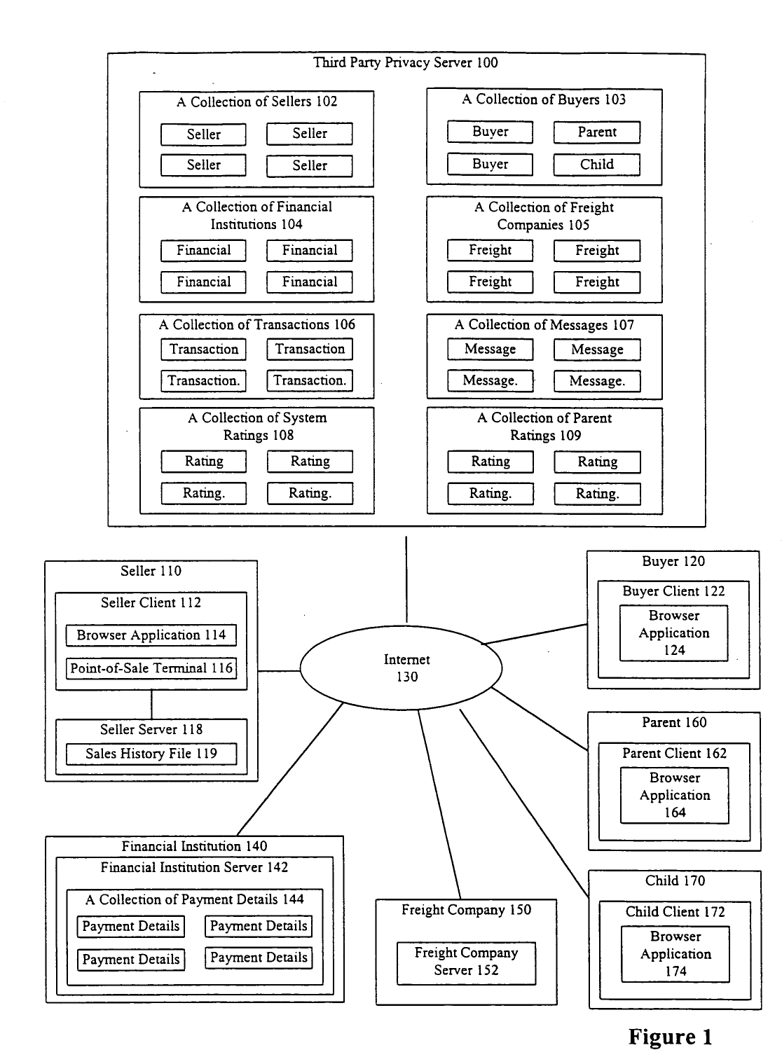

The following illustrates one embodiment of the third party privacy system. FIG. 1 includes a third part privacy server 100, seller 110, buyer 120, the Internet 130, financial institution 140, freight company 150, parent 160, and child 170. The third party privacy server 100 includes a collection of sellers 102, a collection of buyers 103, a collection of financial institutions 104, a collection of freight companies 105, a collection of transactions 106, a collection of messages 107, a collection of system ratings 108, and a collection of parent ratings 109. Seller 110 includes a seller client 112, which includes a browser application 114 and point-of-sale terminal 116. Seller client 112 also includes seller server 118 which includes sales history file 119. Buyer 120 includes buyer client 122 which includes browser application 124. Financial institution 140 includes financial institution server 142, which includes a collection of payment details 144. Freight company 150 includes freight company server 152. Parent 160 includes parent client 162 which includes browser application 164. Child 170 includes child client 172 which includes browser application 174.

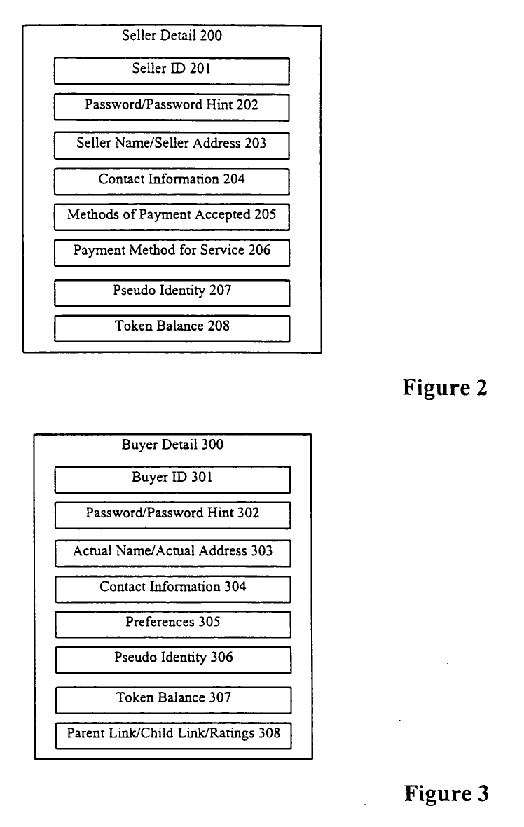

FIG. 2 includes seller detail 200 which includes seller ED 201, password/password hint 202, seller name/seller address 203, contact information 204, methods of payment accepted 205, payment method for service 206, pseudo identity 207, and token balance 208.

FIG. 3 includes buyer detail 300 which includes buyer ID 301, password/password hint 302, actual name/actual address 303, contact information 304, preferences 305, pseudo identity 306, token balance 307, and parent link/child link/ratings 308.

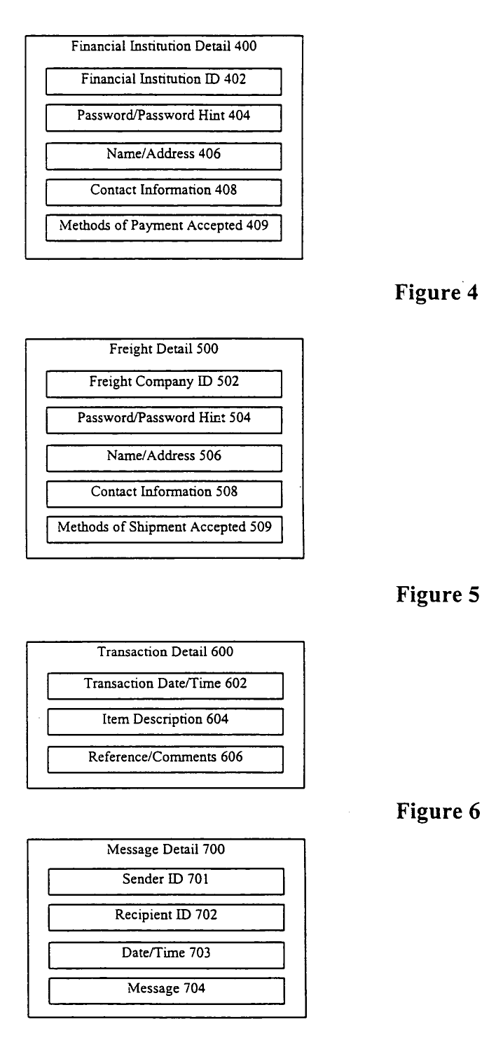

FIG. 4 includes financial institution detail 400 which includes financial institution ID 402, password/password hint 404, name/address 406, contact information 408, and methods of payment accepted 409.

FIG. 5 includes freight detail 500 which includes freight company ID 502, password/password hint 504, name/address 506, contact information 508, and methods of shipment accepted 509.

FIG. 6 includes transaction detail 600 which includes transaction date/time 602, item description 604, and reference/comments 606.

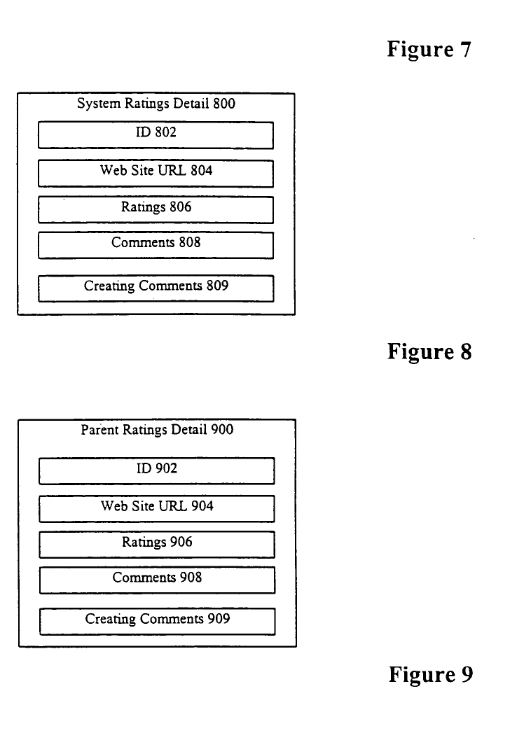

FIG. 7 includes message detail 700, sender ID 701, recipient ID 702, date/time 703, and message 704.

FIG. 8 includes system ratings details 800 which includes ID 802, Web site URL 804, ratings 806, comments 808, and creating comments 809.

FIG. 9 includes parent ratings detail 900 which includes ID 902, Web site URL 904, ratings 906, comments 908, and creating comments 909.

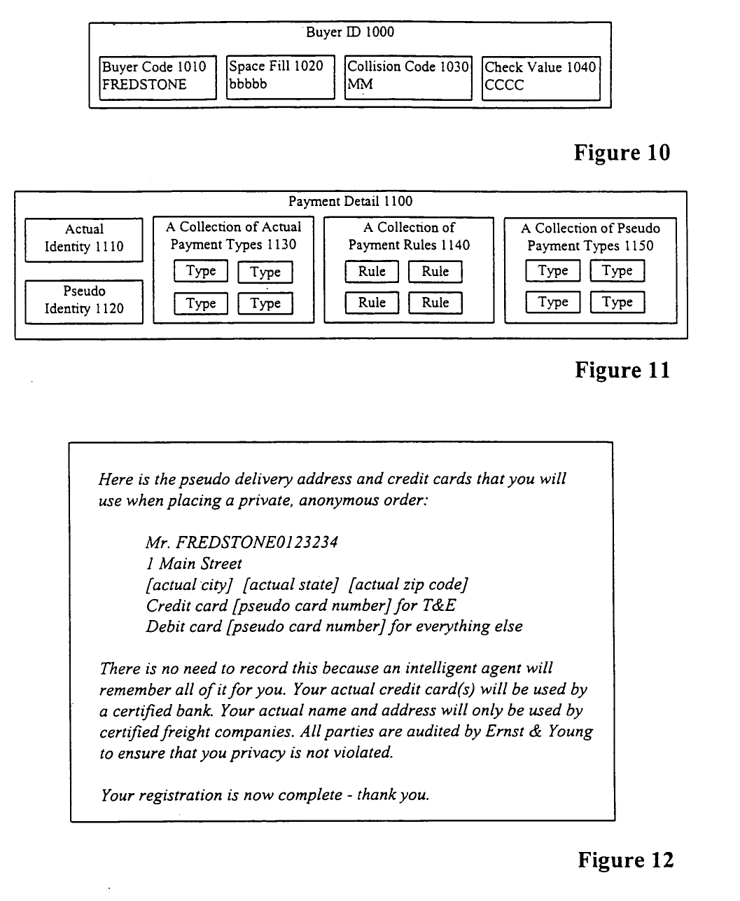

FIG. 10 includes buyer ID 1000 which includes buyer code 1010, space fill 1020, collision code 1030, and check value 1040.

FIG. 11 includes payment detail 1100, which includes actual identity 1110, pseudo identity 1120, a collection of actual payment types 1130, a collection of payment rules 1140 and a collection of pseudo payment types 1150.

FIGS. 12, 13, 14, and 15 illustrate sample screens.

Registration Generally

The following describes the various registration techniques used in some embodiments of the invention. Each of the users of the privacy system needs to register with the privacy server.

Financial Institution Registration

A person from financial institution 140 manually contacts a person at the third party privacy server 100 location to register. The person at the third party privacy server 100 location registers the financial institution 140 by entering identification information, including financial institution ID 402, password/password hint 404, name/address 406, contact information 408 (phone number, fax number, Internet address, email address). Methods of payment accepted 409 by the financial institution server 142 are also entered, including credit card types, debit card types, smart cards types, etc. Financial institution details 400 is stored in a collection of financial institutions 104 in the third party privacy server 100 and confirmation is sent back to the financial information server 142.

In another preferred embodiment, financial institution 140 could use a browser application (and secure communications e.g., SSL) to communicate with the third party privacy server 100 via the Internet 130 to register.

The financial institution 140 registration process ends when a transaction detail 600 is added to a collection of transactions 106 indicating the new financial institution 140 has been added to a collection of financial institutions 104. Each time there is an addition, modification or deletion of information in the third party privacy server 100, a transaction detail 600 is added to a collection of transactions 106.

Freight Company Registration

Similarly, a person from the freight company 150 manually contacts a person at the third party privacy server 100 location to register. The person at the third party privacy server 100 location registers the freight company by entering identification information, including freight company ID 502, password/password hint 504, name/address 506, contact information 508 (phone number, fax number, Internet address, email address). Methods of shipment accepted 509 by the freight company server 152 are also entered, including the information required for the third party privacy server 100 to be a “power shipper” for the freight company 150. Freight detail 500 is stored in a collection of freight companies 105 in the third party privacy server 100 and confirmation is sent back to the freight company server 152.

In another preferred embodiment, freight company 150 could use a browser application to communicate with the third party privacy server 100 via the Internet 130 to register.

The freight company registration process ends when a transaction detail 600 is added to a collection of transactions 106 indicating the new freight company 150 has been added to a collection of freight companies 105. Each time there is an addition, modification or deletion of information in the third party privacy server 100, a transaction detail 600 is added to a collection of transactions 106.

Seller Registration

As shown in FIG. 1, browser application 114 is used by the seller client 112 to access the Internet 130 in order to gain access to a collection of sellers 102 on the third party privacy server 100. In another preferred embodiment, seller client 112 could use an in-store point-of-sale terminal 116 to access a collection of sellers 102. In yet another preferred embodiment, the seller 110 could use a phone or fax to manually communicate with a person at the third party privacy server 100 location, who could then enter the information directly into a collection of sellers 102. Seller client 112 registers by entering identification information, including seller ID 201, password/password hint 202, seller name/seller address 203, contact information 204 (phone number, fax number, Internet address, email address). Methods of payment accepted 205 by seller 110 are also entered. In addition, the payment method for service 206 used by seller 110 to pay for accessing the third party privacy server 100, as well as for paying for tokens for unsolicited messages sent to buyers 120, are entered and could include credit card number, credit card name, credit card expiration date, bank account information, and letter of credit information. The third party privacy server 100 verifies the payment method by sending payment details to a financial institution 140 for verification. Verification is returned and seller detail 200 is stored in a collection of sellers 102. Confirmation is then sent back to the seller 110. In another embodiment, the seller 110 may choose to remain anonymous, in which case, the seller 110 is assigned a pseudo identity in a manner similar to Buyer Registration, described below. Registration is complete when transaction detail 600 is logged in a collection of transactions 106 indicating the addition of the new seller 110.

Note that in another embodiment, the seller 110 could have multiple pickup addresses stored in seller details 200 that could be matched with the address in the pseudo identity 306 of the buyer 110.

Buyer Registration

As shown in FIG. 1, browser application 124 is used by the buyer client 122 to access the Internet 130 in order to gain access to a collection of buyers 103 on the third party privacy server 100. In another preferred embodiment, the buyer 120 could manually contact, by phone, fax or regular mail, a person at the third party privacy server 100 location and have them manually enter the information into a collection of buyers 103. Buyer client 122 registers by entering buyer ID 301, password/password hint 302, actual name/actual address 303, and contact information 304 (phone number, email address, and preferences 305 (consideration amount to be paid by seller client 112 for sending unsolicited promotions to buyer client 122, privacy preferences, category preferences, and delivery preferences).

FIG. 10 shows one embodiment of how the third party privacy server 100 generates a unique buyer ID 1000. Buyer ID 1000 is generated by taking the buyer ID entered by the buyer client 122 and storing it in buyer code 1010, then space-filling space fill 1020 so that the total length of buyer ID 1000 is a fixed length., assigning a code to collision code 1030 to eliminate collisions in buyer ID 1000, and generating a check value 1040, such as a cryptographic hash using DES, of the buyer code 1010, space fill 1020 and collision code 1030. This unique buyer ID 1000 is then stored in buyer detail 300, which is stored a collection of buyers 103 with the other information entered by the buyer client 122.

In another preferred embodiment, the third party privacy server 100 could generate a series of single-use buyer ID's by incrementing the collision code 1030 in the Buyer ID 1000. These unique single-use keys would be given to the buyer 120 in advance and would prevent fraudulent use by a third party, particularly when the risk of fraudulent use is increased, such as when the buyer 120 communicates with a seller 110 over the phone or fax, rather than over the Internet 130. Any time a single-use buyer ID is used more than once, it would indicate a fraudulent use and would permit immediate corrective action to be taken by the third party privacy server 100 and/or seller 110 and/or financial institution 140. However, it is likely that the third party privacy server 100 would identify the error before anything is sent to the financial institution server 142.

The third party privacy server 100 passes control to a financial institution server 142 for payment type registration (not authentication because no payment types have been entered), with the actual name/actual address 303 entered by buyer client 122. FIG. 11 illustrates the creation of a payment detail 1100 in a collection of payment details 144. Actual name/actual address 303 is stored in actual identity 1110. Financial institution server 142 next accepts payment details directly from buyer client 122, including payment card number, card name and card expiration date for each debit, credit, or other type of payment. Other embodiments might include bank checking account number or frequent flyer account number. Financial institution server 142 validates each payment type and stores it in a collection of actual payment types 1130 for buyer 120. If more than one payment type is entered, rules are also entered to determine when a payment type is to be used. In one embodiment, payment type could be determined by the category of a transaction. For example, travel and other related business expenses could be assigned to payment type #1, an American Express credit card stored in a collection of actual payment types 1130, while all other categories could be assigned to payment type #2, a debit card stored in a collection of actual payment types 1130. This will later give the financial institution server 142 more information to intelligently serve the buyer's needs in an increasingly automated shopping environment. In another embodiment, a payment type could be determined by the amount of a transaction. In yet another embodiment, it could be determined by using one payment type until credit is no longer available, then the next type, and so on. These rules are stored in a collection of payment rules 1140.

The financial institution server 142 then assigns a valid but pseudo payment identity, comprised of a pseudo number, pseudo name, and pseudo expiration date to each of the payment types in a collection of actual payment types 1130 and stores them in a collection of pseudo payment types 1150. The financial institution server 142 then creates a pseudo identity for the buyer 120. In one embodiment, this is made up of the buyer ID, a fictitious street address, actual city, state and zip code. This is stored in pseudo identity 1120. Payment details 1100 is then stored in a collection of payment details 144 to complete the payment registration. Note that payment details 1100 is structured in a way that can rapidly link the pseudo payment type with the actual payment types for real-time payment authorization.

Control is then passed back to the third party privacy server 100 with only the pseudo identity 1120 and a collection of pseudo payment types 1150, which is stored in pseudo identity 306. Buyer detail 300 is then stored in a collection of buyers 103. Note that the information from a collection of payment types 1030 and a collection of payment rules 1040 in payment details 1000 in financial institution 140 are unknown to and unwanted by the third party privacy server 100. This limits liability and limits the private information required to be stored by the third party privacy server 100. A confirmation message sent from the third party privacy server 100 to the buyer client 122 is shown in FIG. 12.

In another embodiment, the third party privacy server 100 could assign a pseudo identity 306 for this buyer without having to register a payment type with financial institution 140. This would be for people who want a pseudo identity but do not want to use it for shopping.

Each time there is an addition, modification or deletion of information in the third party privacy server 100, a transaction detail 600 is added to a collection of transactions 106. The buyer registration process is ended when a transaction detail 600 is added to a collection of transactions 106 indicating the new buyer has been added to a collection of buyers 103.

Example Purchases and Returns

The following describes examples of how the privacy system would allow private purchases and returns of physical goods.

Non-eCommerce Sale

Buyer 120 contacts seller 110 by the phone or by an in-store visit. Seller 110 enters the sale information along with the buyer's ID and freight preference (regular, express) into a point-of-sale terminal 116 which is connected to the seller server 118. In one embodiment, the seller 110 generates a reference number and sale category, and sends the seller ID, buyer ID and sale information via the Internet 130 to the third party privacy server 100 for identity authentication. The third party privacy server 100 verifies the seller ID from a collection of sellers 102, and buyer ID from a collection of buyers 103, where it also obtains the buyer's pseudo identity 320.

Next, the third party privacy server 100 determines the preferred payment type for the buyer by generating a temporary payment type table from the pseudo payment types in pseudo identity 320. If there is only one pseudo payment type for the buyer, it is the only item entered in the table. If the sale category from seller is unknown, the first pseudo payment type is entered into the table. Otherwise, the most appropriate pseudo payment type is considered preferred, based on matching categories. Any additional pseudo payment types are also added to the table in case the first type is refused (not authenticated). All pseudo payment types are placed in the temporary table, with the preferred type at the top. The third party privacy server 100 completes the identity authentication by returning the pseudo identity, temporary payment type table, and original reference to the seller server 118 and point-of-sale terminal 116. Since interception of this transaction could permit fraud, the transaction is well protected using digital signatures and SSL with both client and server side certificates.

A sale may or may not require payment authentication or delivery authentication. For example, the buyer 120 might be registering for a free service from the seller 110, in which case neither authentication is required.

If the sale does not require a payment, such as for a free sample, then the following payment authentication is skipped. The seller server 118 next sends the first pseudo payment type in the temporary table and the amount of the sale to the financial institution server 142, for payment authentication. This authentication is in the same manner that any other payment would be authenticated with any financial institution 140, such as through the bank authorization network. In one embodiment, the financial institution server 142 recognizes the payment type as a pseudo type because of a range check of the payment card number, and uses a collection of pseudo payment types 1050, a collection of actual payment types 1030 and a collection of payment rules 1040 to determine the actual payment type to use for the buyer 120. The financial institution server 142 then completes the payment authentication in the regular manner and generates an authorization code which is returned to the seller server 118 and point-of-sale terminal 116, again in the regular manner. Payment authentication is then complete. If the payment authentication is refused, the seller server 118 examines the temporary table to see if other pseudo payment types are available. If they are, the process is repeated for each pseudo payment type until authentication is successful or until there are no more payment types in the table, in which case the buyer 120 is informed of the refusal (not being authenticated).

If the sale does not require any merchandise to be delivered, such as for a service item that has been purchased, then the following delivery authentication is skipped. Otherwise, the seller 110 prepares the sale items for pickup using the reference number generated by the point-of-sale terminal 116. Using the freight preference entered on the point-of-sale terminal 116, the third party privacy server 100 determines the freight detail 500 from a collection of freight companies 105 to use, and the address of the “power shipper” information and required format from methods of shipment accepted 509. The third party privacy server 100 then sends the seller 110 a reference number for this sale, seller name/seller address 203 from seller details 200 in a collection of sellers 102, and actual name/actual address 303 and contact information 304 from buyer detail 300 in a collection of buyers 103, to freight company server 152 for freight authentication. As the “power shipper”, the third party privacy server 100 receives authentication. If it fails, then the third party privacy server 100 informs the seller 110, who informs the buyer 120 and another freight option is authenticated. Note that this might require the seller 110 voiding or altering the sale because of a possible difference in the freight charges. If all freight options fail, then the seller 110 may have to void the entire sale. If the freight authentication is successful, then the freight tracking number is generated by the freight company server 152 and is sent to the third party privacy server 100. The freight authentication of the sale is complete.

The seller 110 completes the sale by verbally giving the seller 110 reference number to the buyer 120 and storing the sale in the sales history file 119 on the seller server 118. Note that any future relationship between the seller 110 and the buyer 120 is by the third party privacy server 100. An ongoing, anonymous, private relationship is therefore possible after the sale has been completed.

Finally, the seller server 118 sends the sale to the third party privacy server 100 by sending the seller ID, buyer ID, reference number, sale information and sale completion code. The sale is completed on the third party privacy server 100 by storing the sale in transaction detail 600 in a collection of transactions 106. This includes seller ID, buyer ID, freight company ID, and other information related to the sale. The seller 110 or buyer 120 can retrieve information from the transaction detail 600 about this or any other sale by using a Seller Inquiry or Buyer Inquiry (described below). Note that this can only be done in a way that respects the privacy and anonymity of the buyer 120 and, in some cases, the seller 110.

If the sale requires a delivery, the freight company server 152 schedules the pickup from the seller 110 in a way that does not identify the buyer 120, but uses the reference number generated by the point-of-sale terminal 116. After the package has been picked up, the freight company delivers the package to the actual name and address of the buyer 120. Note that this process does not require the freight company to contact the third party privacy server 100 during the actual delivery process, thus making the delivery company's processes self-contained and self-dependent.

If the sale requires a buyer 120 payment, such as for credit card usage, the issuing financial institution 140 sends the buyer 120 on a statement at the end of the billing cycle.

Another embodiment could be selecting the pseudo payment type by the amount of the transaction. For example, anything over a certain amount could be charged to American Express, while anything that is personal and less than $5 could be cyber tokens. Everything else could be charged to a debit card.

Another embodiment, the payment authentication of the sale could be processed by a “black box” computer that is licensed to the financial institution 140. This would be a much more secure and acceptable method of processing than actually changing the way the financial institution's internal systems operate.

eCommerce Sale

This type of sale is very similar to the Non-eCommerce Sale described above. The differences are noted as follows. The buyer 120 starts the sale by using browser application 124 in buyer client 122 to access the Internet 130 to locate the seller server 118. Once located, seller server 118 receives the buyer D, which in the preferred embodiment, is entered by the buyer 120 for each sale. In other embodiments, the buyer ID can be retrieved from the buyer client 122, retrieved from another marketplace server, or from an intelligent agent acting on the buyer's 120 behalf. The seller server 118 also receives the items to be purchased from the buyer client 122. The sale is processed in the same way as a Non-eCommerce Sale except decisions that have to be made, such as for payment and freight options, are entered into the buyer client 122 rather than over the phone or from an in-store visit. The sale is completed by the seller server 118 by giving the buyer client 122 the sale reference number. The seller 110 or buyer 120 can retrieve information from the third party privacy server 100 about this or any other sale by using a Seller Inquiry or Buyer Inquiry(described below).

In another embodiment, the seller server 118 could be located and the sale processed by an intelligent agent representing the buyer 120, rather than by direct intervention of the buyer 120 using buyer client 122.

Non-eCommerce Returns

Buyer 120 contacts seller 110 by the phone or by an in-store visit. Seller 110 enters the return sale information along with the buyer's ID and, optionally the buyer's freight preference, into a point-of-sale terminal 116 which is connected to the seller server 118. In the embodiment, the return sale and buyer ID is verified against a sales history file 119 stored on the seller server 118 and, if not located, the return request could be rejected. Otherwise, the seller server 118 generates a return authorization number and sends the seller ID, buyer ID and return information via the Internet 130 to the third party privacy server 100 for identity authentication. The third party privacy server 100 then authenticates the seller ID from a collection of sellers 102, and buyer ID from a collection of buyers 103, where it also obtains the buyer's pseudo identity 306. The third party privacy server 100 creates a temporary payment type table in the same way as described in Non-eCommerce Sale above. The third party privacy server 100 completes the identity authentication by returning the pseudo identity, temporary payment type table, and original reference to the seller server 118 and point-of-sale terminal 116.

If the return does not require a refund, such as for a free sample, then the following refund authentication is skipped. The seller server 118 determines the refund type from the previous payment method from the sales history file 119, or from the payment table, as described in Non-eCommerce Sale. This payment type and refund amount is authenticated by the financial institution as described in Non-eCommerce Sale.

If the return does not require any merchandise to be picked up from the buyer 120 and returned to the seller 110, such as for a service item that is being canceled, the following delivery authentication is skipped. Otherwise, the buyer 120 prepares the return items for pickup using the return authorization code number generated by the point-of-sale terminal 116. As the “power shipper”, the third party privacy server 100 schedules the pickup in the same way as described in Non-eCommerce Sale above, except that the pickup is from the buyer 120 and delivery is to the seller 110, but still in a way that assures the privacy of the buyer 120. Freight authentication of the return is then complete.

The seller 110 completes the return by verbally giving the return authorization number to the buyer 120 and storing the return in the seller server 118. Again, note that any future relationship between the seller 110 and the buyer 120 is by the third party privacy server 100. An ongoing, anonymous, private relationship is therefore possible after the return has been completed.

Finally, the seller client 112 completes the return by sending the seller ID, buyer ID, return authorization number, return information and return completion code to the third party privacy server 100. The return is completed on the third party privacy server 100 by storing a transaction detail 600 in a collection of transactions 106. This includes seller ID, buyer ID, freight company ID, and other information related to the return. The seller 110 or buyer 120 can retrieve information from the third party privacy server 100 about this or any other return by using a Seller Inquiry or Buyer Inquiry (described below).

If the sale requires a buyer 120 refund, such as for credit card usage, the issuing financial institution 140 notes this for the buyer 120 on a statement at the end of the billing cycle.

In another preferred embodiment, the seller 110 may permit a buyer 120 to return an item without contacting the seller 110 first. In this case, the buyer 120 would contact the freight company 150 and have it schedule a pickup from the buyer 120 and have a delivery sent to the seller 110. It would then be up to the seller 110 to enter the return into its point-of-sale terminal 116, which would transmit the return to the third party privacy server 100 so that the transaction could be stored in transaction detail 600 in collection of transactions 106.

eCommerce Return

This type of return is very similar to the Non-eCommerce Return described above. The differences are noted as follows. The buyer 120 starts the return by using browser application 124 in buyer client 122 to access the Internet 130 to locate the seller server 118. Once located, seller server 118 receives the buyer ID, which in the preferred embodiment, is entered by the buyer 120. In other embodiments, the buyer ID can be retrieved from the buyer client 122, retrieved from another marketplace server, or obtained by an intelligent agent working on behalf of the buyer 120. The seller server 118 also receives the items to be returned from the buyer client 122. The return is processed in the same way as a Non-eCommerce Sale except decisions that have to be made, such as for payment and freight options if any, are entered into the buyer client 122 rather than over the phone or from an in-store visit. The return can then be completed by the seller server 118 by giving the buyer client 122 the return authorization number for the return. The seller 110 or buyer 120 can retrieve information from the third party privacy server 100 about this or any other return by using a Seller Inquiries or Buyer Inquiry (described below).

In another preferred embodiment, the seller server 118 could be located and the return processed by an intelligent agent representing the buyer 120, rather than by direct intervention of the buyer 120 using buyer client 122.

Inquiries

The following describes how inquiries will be handled.

Buyer Inquiries

The buyer 120 uses a browser application 124 to access the Internet 130 to gain access to the third party privacy server 100. In another embodiment, the buyer 120 uses other means to access the third party privacy server 100, such as phoning an operator who has access, or a fax to a person with access or in machine readable fax format that could access the third party privacy server 100 without an operator. In the preferred embodiment, the buyer would provide a buyer ID and password or other identifying mechanism to access his or her own buyer detail 300 in a collection of buyers 103, plus the corresponding transaction details 600 for buyer 120 in a collection of transactions 106.

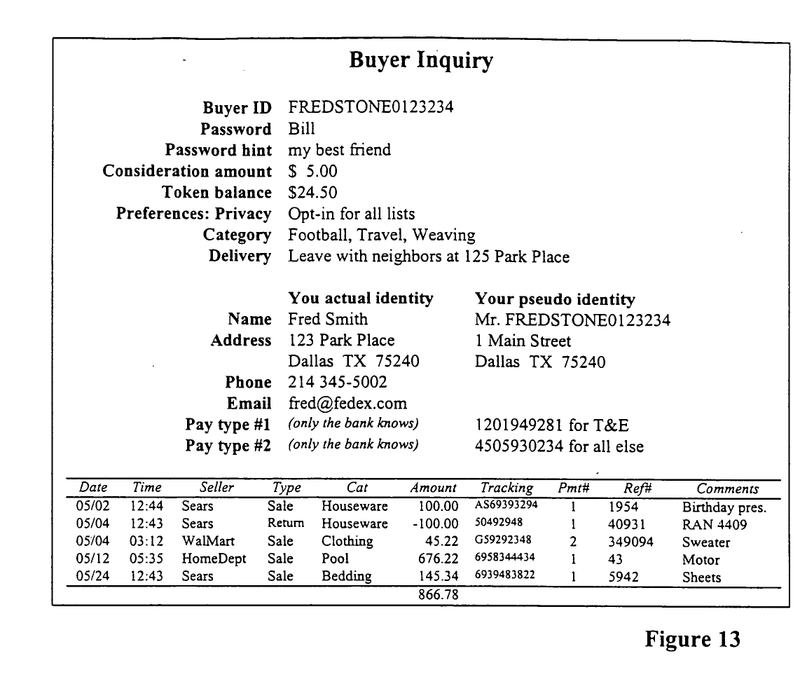

FIG. 13 shows the preferred embodiment of the information returned. The buyer ID, password, password hint, consideration amount, token balance, privacy, category and delivery preferences, actual identity including contact information, and pseudo identity including the pseudo payments are all from buyer detail 300 in a collection of buyers 103. Note that, in this example, two credit cards were specified by the buyer 120, but actual card numbers are unknown to the third party privacy server 100. FIG. 13 also shows the following information from transaction details 600 in a collection of transactions 106: transaction date, transaction time, seller name, transaction type, transaction category, transaction amount, freight tracking code, transaction payment type number, transaction reference number assigned by the seller 110, and transaction comments. The buyer 120 can modify all fields from a collection of buyers 103 except for pseudo payment information. For this, control must be passed to the financial institution 140 in the manner described in Buyer Registration above. The only field in transaction detail 600 that can be changed is comments 606.

In another embodiment, the buyer 120 could also review other related information in a collection of transactions 106, such as which sellers 110 have made Seller Inquiries, discussed below, about buyer 120 for the purpose of prospecting for new business.

Seller Inquiries

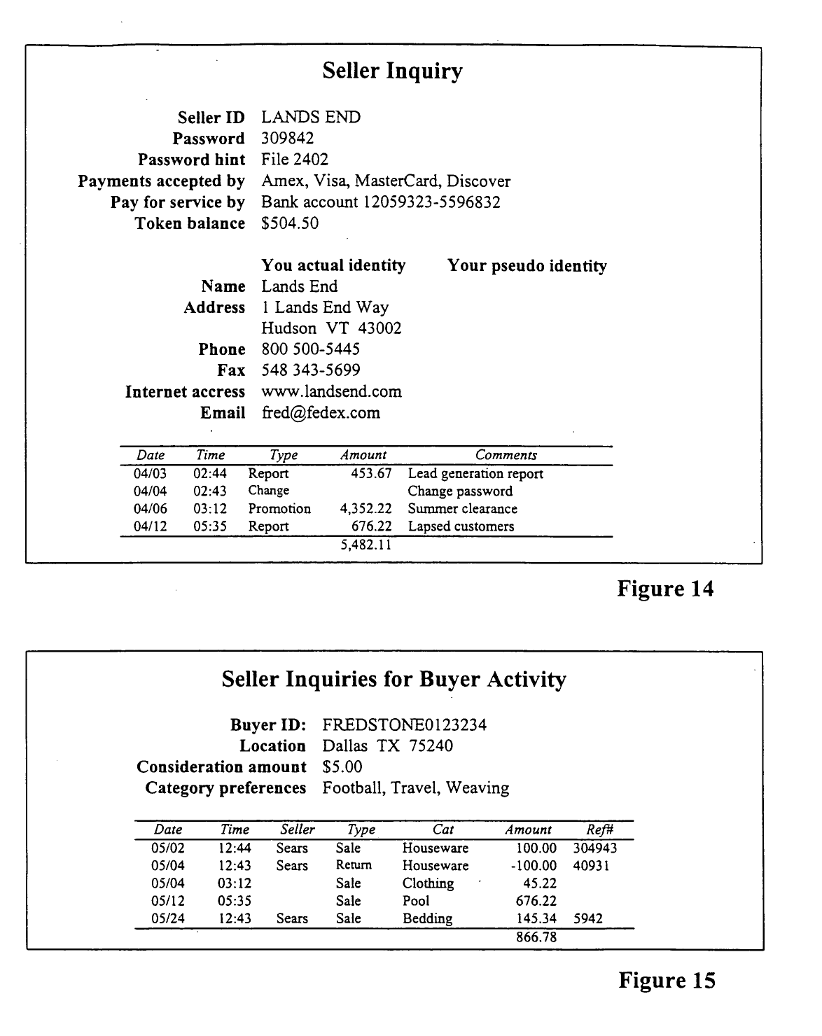

In the preferred embodiment, there are two types of seller inquiries. FIG. 14 shows the information from seller detail 200 in a collection of sellers 102, and a collection of transactions 106 for a specific seller 110. FIG. 15 shows partial information from buyer detail 300 in a collection of buyers 103, and transaction detail 600 for that buyer ID 301 in a collection of transactions 106 for a specific buyer 120 that the seller 110 wants to learn more about.

FIG. 14 shows a sample Seller Inquiry. This is started by the seller 110 using a browser application 114 to access the Internet 130 to gain access to the third party privacy server 100. In another embodiment, the seller 110 uses other means to access the third party privacy server 100, such as a phone call to an operator who has access, or a fax to a person with access or a fax in machine readable format that could access the third party privacy server 100 without an operator. In the preferred embodiment, the seller would provide a seller ID and password or other identifying mechanism to access the correct seller detail 200 in a collection of sellers 102, and corresponding transaction details 600 in a collection of transactions 106.

FIG. 14 shows one embodiment of the information returned. The seller ID, password, password hint, methods of payment accepted, payment method for service, actual name, address, phone, fax, Internet address and email address are all from seller detail 200 in a collection of sellers 102. In another embodiment, the seller 110 could also have a pseudo identity if the seller 110 wishes to remain anonymous to buyers 120. FIG. 14 also shows the following related information from transaction detail 600 in a collection of transactions 106: transaction date, transaction time, transaction type, transaction amount, and transaction comments. The seller 110 can modify all fields in seller detail 200 from a collection of sellers 102. The only field in transaction detail 600 from a collection of transactions 106 that can be changed is comments 606.

In another embodiment, other information from a collection of transactions 106 could be shown, such as activity for a certain product line, sales for a certain time period, or activity for a specific location. In yet another embodiment, the information from a collection of transactions 106 could be in summary form by combining similar transactions.

FIG. 15 shows another sample Seller Inquiry where the seller 110 would identify a specific buyer 120 by entering the buyer ID. FIG. 15 shows one embodiment of the information returned. The buyer ID, location, consideration amount for unsolicited promotions, remaining token balance, and category preferences are from buyer detail 300. Note that no information is shown that could be used to identify the identity of buyer 120. FIG. 15 also shows the following related information from transaction details 600 from a collection of transactions 106 for buyer ID 301: transaction date, transaction time, seller, transaction type, transaction category, transaction amount, and transaction reference assigned by the seller 110. Note that seller and reference number are only shown if this transaction is for the seller 110 making this inquiry. In this embodiment, the seller 110 cannot modify any fields in this screen.

In another embodiment, other information from a collection of transactions 106 could be shown, such as activity for a certain product line, sales for a certain time period, or activity for a specific location. In yet another embodiment, the information from a collection of transactions 106 could be in summary form by combining similar transactions. In another embodiment, the information from a collection of transactions 106 could be for a group of buyers 120 who share the same characteristics or behavior.

In another embodiment, all of the information in seller inquiries could be retrieved electronically and sent to the seller server 118 for later processing.

Financial Institution Inquiries

A financial institution 140 could also make inquiries in a similar manner as described in Seller Inquiries above. These inquires could also be for the routine maintenance of financial institution detail 400 by a specific financial institution 140 or for inquiries related to one or more buyers 120 from buyer detail 300 and the corresponding transaction details 600.

Freight Company Inquiries

A freight company 150 could also make inquiries in a similar manner as described in Seller Inquiries above. These inquires could also be for the routine maintenance of freight detail 500 for a specific freight company 150 or for inquiries related to one or more buyers 120 from buyer detail 300 and the corresponding transaction details 600.

Non-eCommerce Charge-back

A buyer 120 may disagree with a charge from a financial institution 140. In the preferred embodiment, the following charge-back is described. The buyer 120 uses Buyer Inquiry, described above, to locate the transaction in question from a collection of transactions 106 in the third party privacy server 100. The buyer then contacts the financial institution 140 by phone or by accessing the financial institution server 142, and identifies himself or herself by providing a buyer ID or actual payment method or pseudo payment method. The financial institution server 142 authenticates the buyer 120 and buyer's claim, and processes the charge-back in the regular manner against the seller 110, but by using the pseudo payment method so that the buyer 120 remains anonymous. If the seller 110 wants to get more information about the buyer 120, Buyer Inquiries, described above, can be used. If the seller 110 wants to communicate with the buyer 120, an Anonymous Message, described below, can be sent from the seller server 118 to the buyer client 122 via the third party privacy server 100.

Tracking Missing Deliveries

The buyer 120 uses Buyer Inquiries described above to locate the freight tracking number from a collection of transactions 106 for the missing delivery. As the “power shipper”, the third party privacy server 100 can then access the freight company server 152 to obtain the exact status of the delivery, which is then sent back to the buyer 120. In another embodiment, the buyer 120 phones a person at the third party privacy server 100 location and has this person make the inquiry for them. Yet another embodiment could have the information accessed electronically from the buyer's client 122 and returned directly to the buyer's client 122.

In another embodiment, the seller 110, could have access to the delivery information, but only in a way that assures the anonymity of the buyer 120. This would probably require changes to be made on the freight company server to distinguish whether the actual delivery address or the pseudo delivery address is to be shown to the person making the inquiry.

Anonymous Messages

A seller 110 can communicate with a buyer, either as a result of a sale or in an effort to make a sale. In one embodiment, the seller 110 uses a browser application 114 in seller client 112 to access the Internet 130 and the third party privacy server 100 to locate a specific buyer detail 300 in collection of buyers 103, as described in Seller Inquiries above. If the seller agrees to pay the buyer 120 the consideration amount for unsolicited offers and messages, the seller's token balance 208 in seller detail 200 is debited and the buyer's token balance 307 in buyer detail 300 is credited, and the message is sent from seller server 118 to message detail 700 in a collection of messages 107 on the third party privacy server 100. The message is then processed for the buyer 120 in the preferred manner as described the above noted related patent applications. The buyer 120 can choose to reply or respond to the message, or can initiate his or her own anonymous messages to the seller 110 in a similar manner.

In another embodiment, the seller 110 may choose to have a message or promotion sent to many buyers 120, as described in the application entitled “Analysis and Communication Tools for a System,” application No. 60/057,685, filed Aug. 27, 1997. In yet another embodiment, all communication between the seller 110 and buyer 120 can be electronic without the use of a browser application 114.

In another embodiment, the seller 110 might want to remain anonymous, in which case the buyer 120 can only respond to the seller 110 through the third party privacy server 100, in a manner similar to a seller-initiated message described above.

In the preferred embodiment, when the seller's token balance 208 falls to below a predefined amount, the third party privacy server 100 uses payment method for service 206 to charge the seller 110 for more tokens, which are then credited to token balance 208 in seller detail 200. Also note that a buyer 120 can use his or her own token balance 307 as a payment method for a sale, or can redeem these tokens from the third party privacy server 100 for cash.

Note that messages can also be from buyer 120 to buyer 120, which includes any combination of buyer 120, parent 160 or child 170. Also, the structure of a buyer ID can be the same as a seller ID and must be unique for both buyers and sellers.

Another Embodiment—Combining the Privacy and Financial Servers

The previous description is for a stand-alone third party server 100. Another preferred embodiment would integrate the third party privacy server 100 with the financial institution server 142. The seller 110 would get a sale from the buyer 120, such as over the phone or directly from a browser application 124 as described above. The buyer 120 would identify themselves with their pseudo payment information. After the sale has been received by the seller server 118, the seller server 118 sends the pseudo payment information and sale amount to the financial institution server 142 for identity and payment authentication, where it is processed in the same manner as described above. Briefly, financial institution server 142 converts the pseudo payment information into actual payment information, authenticates it, and returns it to the seller client 112 with an encrypted delivery address of the buyer. When the sale is completed, the seller client 112 schedules the delivery by passing the sales reference number and encrypted delivery address to the freight company server 152. The package is picked up by the freight company 150, the address is decrypted and the package is delivered to the buyer 120 without ever revealing the actual name and address of the buyer 120 to the seller 110. Return requests would be processed in a similar manner, where the financial institution 140 authenticates the pseudo payment information and includes an encrypted buyer 120 pickup address and normal seller 110 delivery address, again without ever revealing the actual name and address of the buyer 120.

Children's Privacy

As described above, a buyer 120 can register on the third party privacy server 100 and be assigned a pseudo identity that permits him or her to have an anonymous relationship with sellers 110. There is nothing to prevent a child from also registering and being assigned a pseudo identity in order to protect the privacy of that child.

Parent/Child Registration

How a parent or child accesses the third party privacy server 100 is functionally identical to the way a buyer accesses the third party privacy server. However, for the sake of clarity, the parent 160 uses browser application 164 and parent client 162 to access the Internet 130, and the child 170 uses browser application 174 and child client 172 to access the Internet 130. Also, for the sake of clarity, the actual key is in brackets. The parent 160 registers in the same manner described in Buyer Registration described above, with the following exceptions: the parent 160 also enters the child ID (buyer ID 301) of each child 170, which is stored in parent link/child link/ratings 308 for the parent record (buyer detail 300). The parent 160 then registers each child 170 in the same manner, this time specifying the parent ID (buyer ID in 301) which is stored in parent link/child link/ratings 308 for the child record (buyer detail 300). The parent also stores the ratings, discussed in a Web Rating System below, that the child 170 is permitted to access in parent link/child link/ratings 308. Note that parent link/child link/ratings 308 is structured in a manner so that the third party privacy server 100 can immediately determine if the current buyer detail 300 is for a parent 160 or a child 170, as well as determine the corresponding child 170 records for a given parent 160, or parent 160 record for a given child 170.

Accessing Web Sites, a Child Remaining Anonymous

The parent 160 accesses Web sites, shops, pays for, and takes delivery of items, returns items, makes inquiries, traces missing packages, etc. in exactly the same way as described for buyers 120 above. The child can also access Web sites but cannot purchase any items because of the missing payment information in pseudo identity 306. Specifically, the child can access Web sites and register for games, free samples, and the various other things being offered by sellers 110, by entering their child ID (buyer ID 301) at the seller server 118, but not their name, address, or any other identifiable information. This then permits the child 170 to have an anonymous relationship with the seller 110 (or any Web site owner). If the seller 110 requires more information, the seller 110 makes a Seller Inquiry, described above, and sees a warning on the screen explaining that this person is a child. The seller 110, or anyone else, can therefore have an anonymous relationship with the child 170 and visa versa by sending Anonymous Messages, as described above.

Parental Supervision of the Child's Relationships

Every time a seller 110 accesses the third party privacy server 100 to inquiry about a child 170, or every time there is an Anonymous Message sent to or from the child 170, the child's parent link/child link/ratings 308 is used to identify the parent 160 (buyer ID 301) and the event is logged in transaction detail 600 in a collection of transactions 106 for the parent 160. This permits all anonymous behavior of the child 170 to be monitored by the parent 160.

Web Rating System

A collection of system ratings 108 on the third party privacy server 100 contains records described in system ratings detail 800. Each record contains an ID 802 of a buyer 110, seller 120, parent 160 or child 170 being rated, a Web site URL 804, a rating 806 with the ratings for the ID 802 or Web site URL 804 and is similar to the TV ratings system that describes adult content, violence content, suggested age groups, etc., comments 808 used to describe the rationale behind the ratings 806 given, and creating comments 809 containing the creating date, time and author ID of the system ratings detail 800. In each system ratings detail 800, at least one of ID 802 and Web site URL 804 must be specified.

A parent 160 can maintain his or her own personal parent ratings detail 900 to override or add to records in system ratings detail 800. The fields are the same.

Each time a child 170, as defined in parent link/child link/ratings 308, tries to send or receive an anonymous message, the third party privacy server 100 accesses parent ratings detail 900 to see if the person receiving the message from the child 170 or sending the message to the child 170 has a record in parent ratings detail 900 with the same ID 902. If there is no record, system ratings detail 800 is also checked in the same manner. If there is no record in either parent ratings detail 900 or ratings system detail 800, the anonymous message is processed as described in Anonymous Messages above, and the event is recorded in transaction detail 600 for the parent 160 referenced in the parent link/child link/ratings 308 for that child 170.

If there is a match, the rating in the child's parent link/child link/ratings 308 is compared to the ratings 906 or 806 to see if this child 170 is permitted access to this ID. If permission is granted, the message is processed as though no record in parent ratings detail 900 or system ratings detail 800 was found. If permission is not granted, then the message is not processed and the event is recorded in transaction detail 600 for the parent 160 referenced in the parent link/child link/ratings 308 for that child 170.

In a similar manner, each time a child 170 tries to access a Web site, a plug-in in the browser application 174 for the child 170 asks permission from the third party privacy server 100, by accessing parent ratings detail 900 and then system rating detail 800, this time matching the desired URL with Web site URL 904 or 804 respectively. Permission is granted or not granted, and processing continues or is stopped, in the same manner described for a child 170 sending or receiving messages.

1-5. (Canceled).

6. A method comprising:
establishing for a first user of an electronic network a key with a single-use characteristic, the key including a pseudo payment type; and
using the key and the single-use characteristic thereof to facilitate through the network a purchase by the first user of something from a second user, including using the pseudo payment type to facilitate payment for the purchase to the second user on behalf of the first user.

7. A method according to claim 6, including configuring the pseudo payment type to contain an identification of a financial institution which is different from each of the first and second users.

8. A method according to claim 7, wherein the using of the pseudo payment type includes communicating through the network with the financial institution, the financial institution making a payment to the second user on behalf of the first user.

9. A method according to claim 6,
wherein the first user maintains an actual payment type; and
wherein the using of the pseudo payment type to facilitate payment includes making a payment to the second user on behalf of the first user under the pseudo payment type, while making a charge against the actual payment type without revealing the actual payment type to the second user.

10. A method according to claim 9, including:
selecting as the actual payment type an actual credit account; and
configuring the pseudo payment type to appear to be a credit account.

11. A method according to claim 6, including configuring the key to include a pseudo identity for the first user, the using of the key including providing the pseudo identity to the second user without revealing to the second user an actual identity of the first user.

12. A method according to claim 11, including configuring the pseudo identity to be a single-use pseudo identity, the single-use pseudo identity serving as the single-use characteristic of the key.

13. A method according to claim 6, including configuring the pseudo payment type to include a pseudo expiration date which is provided to the second user.

14. A method according to claim 6, including establishing a pseudo identity for the second user, the pseudo identity of the second user being provided to the first user without revealing to the first user an actual identity of the second user.

15. An apparatus comprising an electronic system that includes:
a first portion which establishes for a first user of an electronic network a key with a single-use characteristic, the key including a pseudo payment type; and
a second portion which facilitates use of the key and the single-use characteristic thereof to effect through the network a purchase by the first user of something from a second user, including use of the pseudo payment type to facilitate payment for the purchase to the second user on behalf of the first user.

16. An apparatus according to claim 15, wherein the pseudo payment type contains an identification of a financial institution which is different from each of the first and second users.

17. An apparatus according to claim 16, wherein the use of the pseudo payment type includes the second portion facilitating communication through the network with the financial institution to arrange for the financial institution to make a payment to the second user on behalf of the first user.

18. An apparatus according to claim 15,
wherein the first user maintains an actual payment type; and
wherein the use of the pseudo payment type includes the second portion facilitating payment of an amount to the second user on behalf of the first user under the pseudo payment type, while making a charge for the amount against the actual payment type without revealing the actual payment type to the second user.

19. An apparatus according to claim 15, wherein the first portion configures the key to include a pseudo identity for the first user, the use of the key including provision of the pseudo identity to the second user without revealing to the second user an actual identity of the first user.

20. An apparatus according to claim 19, wherein the first portion configures the pseudo identity to be a single-use pseudo identity which serves as the single-use characteristic of the key.

21. An apparatus according to claim 15, wherein the first portion configures the pseudo payment type to include a pseudo expiration date which is provided to the second user.

22. An apparatus according to claim 15, wherein the first portion establishes for the second user a pseudo identity that is provided to the first user without revealing to the first user an actual identity of the second user.

23. A method comprising:
establishing at a financial institution a pseudo payment type for a user; and
using the pseudo payment type to make a monetary payment on behalf of the user to a party other than the financial institution, without revealing to that party an actual identity of the user.

24. A method according to claim 23, including configuring the pseudo payment type to include at least one of a pseudo number, a pseudo name, and a pseudo expiration date.

25. A method according to claim 23, including configuring the pseudo payment type to include one of a pseudo credit card number, a pseudo debit card number, a pseudo bank account number, and a pseudo frequent flyer account number.

26. A method according to claim 23,
including identifying for the financial institution an actual payment type of the user; and
wherein the using of the pseudo payment type includes making a charge against the actual payment type, without revealing the actual payment type to the party receiving the payment under the pseudo payment type.

27. A method according to claim 23, including establishing at the financial institution a further pseudo payment type for the user.

28. A method according to claim 27,
including identifying for the financial institution two actual payment types of the user which are different;
including associating each of the actual payment types with a respective one of the pseudo payment types; and
wherein using of either pseudo payment type includes making a charge against the associated actual payment type, without revealing the associated actual payment type to the party receiving the monetary payment.

29. A method according to claim 27, including establishing at the financial institution a rule set defining when to use each of the pseudo payment types.

30. A method according to claim 29,
including establishing at a privacy server separate from the financial institution a pseudo identity for the user; and
withholding from the privacy server information regarding the actual payment types and the rule set.

31. A method according to claim 30, including:
transmitting from a selected party to the privacy server a request for payment information;
responding to the request by transmitting from the privacy server to the selected party a list of the pseudo payment types in a selected order;
sending from the selected party to the financial institution an authentication request for the first pseudo payment type in the list; and
responding to a denial of authentication for the first pseudo payment type in the list by sending from the selected party to the financial institution an authentication request for the second pseudo payment type in the list.

32. A method according to claim 23, including establishing at a privacy server separate from the financial institution a pseudo identity for the user.

33. A method according to claim 32, including withholding from the privacy server information regarding the pseudo payment type.

34. A method according to claim 32, including registering the financial institution with the privacy server in advance of the establishing of the pseudo payment type.

35. An apparatus comprising an electronic system that includes:
a first portion which establishes at a financial institution a pseudo payment type for a user; and
a second portion which makes under the pseudo payment type a monetary payment on behalf of the user to a party other than the financial institution, without revealing to that party an actual identity of the user.

36. An apparatus according to claim 35, wherein the first portion configures the pseudo payment type to include at least one of a pseudo number, a pseudo name, and a pseudo expiration date.

37. An apparatus according to claim 35, wherein the first portion configures the pseudo payment type to include one of a pseudo credit card number, a pseudo debit card number, a pseudo bank account number, and a pseudo frequent flyer account number.

38. An apparatus according to claim 35,
wherein the first portion accepts information identifying an actual payment type of the user; and
wherein the second portion makes a charge against the actual payment type, without revealing the actual payment type to the party receiving the monetary payment under the pseudo payment type.

39. An apparatus according to claim 35, wherein the first portion establishes at the financial institution a further pseudo payment type for the user.

40. An apparatus according to claim 39, wherein the first portion: accepts information identifying two actual payment types of the user that are different; associates each of the actual payment types with a respective one of the pseudo payment types; and makes a charge against a respective actual payment type in association with each monetary payment made under any pseudo payment type, without revealing the associated actual payment type to the party receiving the monetary payment under the pseudo payment type.

41. An apparatus according to claim 39, wherein the first portion maintains a rule set defining when to use each of the pseudo payment types.

42. An apparatus according to claim 41,
including a privacy server;
including a third portion which establishes at the privacy server a pseudo identity for the user; and
wherein the first portion withholds from the third portion information regarding the actual payment types and the rule set.

43. An apparatus according to claim 42,
including a fourth portion which is associated with a selected party and which transmits from the selected party to the third portion at the privacy server a request for payment information;
wherein the third portion at the privacy server responds to the request by transmitting to the fourth portion a list of the pseudo payment types in a selected order;
wherein the fourth portion thereafter sends to the first portion a request for payment authentication by the financial institution with respect to the first pseudo payment type in the list; and
wherein the fourth portion responds to a denial of authentication for the first pseudo payment type in the list by sending to the first portion a request for payment authentication by the financial institution with respect to the second pseudo payment type in the list.

44. An apparatus according to claim 35, including:
a privacy server; and
a third portion which establishes at the privacy server a pseudo identity for the user.

45. An apparatus according to claim 44, wherein the first portion withholds from the third portion information regarding the pseudo payment type.

46. An apparatus according to claim 44, wherein the third portion registers the financial institution before the first portion establishes the pseudo payment type.
